(19) United States
(12) Patent Application Publication
(10) Pub. No.: US 2026/0057387 A1
(43) Pub. Date: Feb. 26, 2026

(54) NEGOTIABLE PAYMENT INSTRUMENT IN-CLEARING ALERT SYSTEM

(71) Applicant: Early Warning Services, LLC, Scottsdale, AZ (US)

(72) Inventors: Tushar Agarwal, Scottsdale, AZ (US); Syed Badar, Scottsdale, AZ (US); Benjamin Chance, Scottsdale, AZ (US); Abhishek Murthy, Scottsdale, AZ (US); Niranjan Shetty, Scottsdale, AZ (US); Shahana Sayeed, Scottsdale, AZ (US); Raphaella Lancia, Scottsdale, AZ (US)

(73) Assignee: Early Warning Services, LLC, Scottsdale, AZ (US)

(21) Appl. No.: 18/885,103

(22) Filed: Sep. 13, 2024

Related U.S. Application Data
(60) Provisional application No. 63/686,029, filed on Aug. 22, 2024.

(51) Int. Cl. G06Q 20/40; G06Q 20/04; G06V 30/10

(52) U.S. Cl. CPC G06Q 20/4016; G06Q 20/042; G06V 30/10

(57) ABSTRACT

A method of assessing risk of a negotiable instrument may include receiving a deposit inquiry from a depositing financial institution. The deposit inquiry may include a first routing number of an issuing financial institution, a first account number of a check issued by the issuing financial institution, a second routing number of a deposit account, and a second account number of the deposit account. The method may include retrieving risk factors associated with the first account number using the first account number and the first routing number and risk factors associated with the second account number using the second account number and the second routing number. The method may include providing the risk factors associated with the first account number to the depositing financial institution and providing the risk factors associated with the second account number to the issuing financial institution.

### CROSS-REFERENCE TO RELATED APPLICATIONS

This application claims the benefit of U.S. Provisional Application Ser. No. 63/686,029, filed Aug. 22, 2024, entitled “CHECK IN-CLEARING”, the disclosure of which is incorporated by reference herein in its entirety.

### BACKGROUND OF THE INVENTION

Issuing banks lose between USD 100 million to USD 250 million to negotiable payment instrument in-clearing losses each year because the issuing banks do not have sufficient information to quickly and accurately detect fraudulent negotiable payment instruments. In the U.S., the risk associated with clearing a fraudulent negotiable payment instrument is based on whether the issuing bank and/or depositing bank has accepted or denied a negotiable payment instrument within a predetermined time period. For example, where the depositing bank has accepted a negotiable payment instrument, if the issuing bank returns a fraudulent negotiable payment instrument within 24 hours the depositing bank takes the loss and if the issuing bank returns a fraudulent negotiable payment instrument after 24 hours the issuing bank takes the loss. The depositing bank is able to reduce its risk by making an informed decision on whether a particular negotiable payment instrument includes a high risk of fraud. For example, conventionally, when a negotiable payment instrument is presented at a depositing bank, the depositing bank may receive information associated with the issuing bank account using the routing number and account number printed on the negotiable payment instrument. This information associated with the issuing bank account may be used by the depositing bank to determine whether the negotiable payment instrument is likely accurate or fraudulent and to determine whether funds should be requested from the issuing bank. However, the issuing bank does not currently have any mechanism that enables the issuing bank to analyze details associated with an account at the depositing bank within which the negotiable payment instrument is to be deposited. Thus, the issuing bank has a much more difficult time determining whether the negotiable payment instrument is accurate or fraudulent and to determine whether to release the funds indicated on the negotiable payment instrument. Therefore, improvements in negotiable payment instrument in-clearing processes are desired to help reduce the fraud risk to issuing banks.

### BRIEF SUMMARY OF THE INVENTION

Risk assessment system may include one or more processors and a memory having instructions stored thereon that, when executed by the one or more processors, cause the one or more processors to receive a deposit inquiry from a depositing financial institution. The deposit inquiry may include a first routing number associated with an issuing financial institution. The deposit inquiry may include a first account number associated with a negotiable payment instrument issued by the issuing financial institution. The deposit inquiry may include a second routing number associated with a deposit account into which funds from the negotiable payment instrument are to be deposited. The deposit inquiry may include a second account number associated with the deposit account. The instructions may cause the one or more processors to retrieve one or more risk factors associated with the first account number using the first account number and the first routing number. The instructions may cause the one or more processors to retrieve one or more risk factors associated with the second account number using the second account number and the second routing number. The instructions may cause the one or more processors to provide the one or more risk factors associated with the first account number to the depositing financial institution. The instructions may cause the one or more processors to provide the one or more risk factors associated with the second account number to the issuing financial institution.

In some embodiments, the one or more risk factors associated with the first account number and the one or more risk factors associated with the second account number may include at least one of: an average balance of an account associated with the respective account number, a negotiable payment instrument velocity of the account associated with the respective account number, a negotiable payment instrument velocity of an account holder of the account associated with the respective account number across one or more financial institutions, an age of the account associated with the respective account number, a number of owners and signors of the account associated with the respective account number, a past risk history of the owners and signors of the account associated with the respective account number, information related to past returns on the account of the account associated with the respective account number, information related to Fair Credit Reporting Act violations of the account associated with the respective account number, or information related to payment transaction fraud of the account associated with the respective account number. The deposit inquiry may include an image of the negotiable payment instrument. The image may include the first routing number and the first account number. The instructions may further cause the one or more processors to extract the first routing number and the first account number from the image of the negotiable payment instrument, identify an owner of an account associated with the negotiable payment instrument based on the first routing number and the first account number, send the image of the negotiable payment instrument, the first routing number, and the first account number to the issuing financial institution, receive a verification decision from the issuing financial institution, the verification decision indicating whether the owner of the account has marked the negotiable payment instrument as accurate or fraudulent, and provide the verification decision to the depositing financial institution. The deposit inquiry may include an image of the negotiable payment instrument. The image may include the first routing number and the first account number. The instructions may further cause the one or more processors to extract the first routing number and the first account number from the image of the negotiable payment instrument, identify an owner of an account associated with the negotiable payment instrument, determine an electronic messaging address of the owner of the account, send the image of the negotiable payment instrument, the first routing number, and the first account number to the electronic messaging address of the owner, receive a verification decision from the owner of the account, the verification decision indicating whether the owner of the account has marked the negotiable payment instrument as accurate or fraudulent, and provide the verification decision to the depositing financial institution. The electronic messaging address may include at least one of a phone number, an email address, or an identifier associated with a mobile application associated with the issuing financial institution. The owner of the account associated with the negotiable payment instrument may be identified based on the first routing number and the first account number. The deposit inquiry may be one of a plurality of deposit inquiries that are received by the risk assessment system in a batch. The instructions may further cause the one or more processors to determine whether the negotiable payment instrument has been previously presented at another financial institution, and providing an indication of whether the negotiable payment instrument has been previously presented at another financial institution to the depositing financial institution.

Methods of assessing risk of a negotiable instrument may include receiving, by a risk assessment system, a deposit inquiry from a depositing financial institution. The deposit inquiry may include a first routing number associated with an issuing financial institution. The deposit inquiry may include a first account number associated with a negotiable payment instrument issued by the issuing financial institution. The deposit inquiry may include a second routing number associated with a deposit account into which funds from the negotiable payment instrument are to be deposited. The deposit inquiry may include a second account number associated with the deposit account. The methods may include retrieving, by the risk assessment system, one or more risk factors associated with the first account number using the first account number and the first routing number. The methods may include retrieving, by the risk assessment system, one or more risk factors associated with the second account number using the second account number and the second routing number. The methods may include providing, by the risk assessment system, the one or more risk factors associated with the first account number to the depositing financial institution. The methods may include providing, by the risk assessment system, the one or more risk factors associated with the second account number to the issuing financial institution.

In some embodiments, the methods may include generating a risk score based at least in part on the one or more risk factors associated with the first account number. The methods may include sending the risk score to the depositing financial institution. The methods may include generating a risk score based at least in part on the one or more risk factors associated with the second account number. The methods may include sending the risk score to the issuing financial institution. The methods may include using a machine learning model to generate at least one risk score. The at least one risk score may include one or both of a first risk score associated with the first account number and a second risk score associated with the second account number. The methods may include sending each of the at least one risk score to one or both of the issuing financial institution and the depositing financial institution. The machine learning model may be trained using historical information from known fraudulent negotiable payment instruments. The deposit inquiry may be received in real-time immediately upon the depositing financial institution accepting the negotiable payment instrument.

Non-transitory machine-readable mediums may have instructions stored thereon that, when executed by one or more processors, cause the one or more processors to receive a deposit inquiry from a depositing financial institution. The deposit inquiry may include a first routing number associated with an issuing financial institution. The deposit inquiry may include a first account number associated with a negotiable payment instrument issued by the issuing financial institution. The deposit inquiry may include a second routing number associated with a deposit account into which funds from the negotiable payment instrument are to be deposited. The deposit inquiry may include a second account number associated with the deposit account. The instructions may cause the one or more processors to retrieve one or more risk factors associated with the first account number using the first account number and the first routing number. The instructions may cause the one or more processors to retrieve one or more risk factors associated with the second account number using the second account number and the second routing number. The instructions may cause the one or more processors to provide the one or more risk factors associated with the first account number to the depositing financial institution. The instructions may cause the one or more processors to provide the one or more risk factors associated with the second account number to the issuing financial institution.

In some embodiments, the deposit inquiry may include an image of the negotiable payment instrument, the image may include the first routing number and the first account number. The instructions may further cause the one or more processors to extract the first routing number and the first account from the image of the negotiable payment instrument, identify an owner of an account associated with the negotiable payment instrument based on the first routing number and the first account, send the image of the negotiable payment instrument, the first routing number, and the first account to the issuing financial institution, receive a verification decision from the issuing financial institution, the verification decision indicating whether the owner of the account has marked the negotiable payment instrument as accurate or fraudulent, and provide the verification decision to the depositing financial institution. The deposit inquiry may include an image of the negotiable payment instrument, the image may include the first routing number and the first account number. The instructions may further cause the one or more processors to extract the first routing number and the first account from the image of the negotiable payment instrument, identify an owner of an account associated with the negotiable payment instrument, determine an electronic messaging address of the owner of the account, send the image of the negotiable payment instrument, the first routing number, and the first account to the electronic messaging address of the owner, receive a verification decision from the owner of the account, the verification decision indicating whether the owner of the account has marked the negotiable payment instrument as accurate or fraudulent, and provide the verification decision to the depositing financial institution.

In some embodiments, the instructions may further cause the one or more processors to generate a risk score based at least in part on the one or more risk factors associated with the first account number and send the risk score to the depositing financial institution. The instructions may further cause the one or more processors to generate a risk score based at least in part on the one or more risk factors associated with the second account number and send the risk score to the issuing financial institution. The instructions may further cause the one or more processors to use a machine learning model to generate at least one risk score. The at least one risk score may include one or both of a first risk score associated with the first account number and a second risk score associated with the second account number. The instructions may further cause the one or more processors to send each of the at least one risk score to one or both of the issuing financial institution and the depositing financial institution.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a system for performing a negotiable payment instrument in-clearing process in accordance with the present invention.

FIG. 2 is a swimlane diagram of a process for performing a negotiable payment instrument in-clearing process in accordance with the present invention.

FIG. 2A is a swimlane diagram of a process for performing a negotiable payment instrument in-clearing process in accordance with the present invention.

FIG. 2B is a swimlane diagram of a process for performing a negotiable payment instrument in-clearing process in accordance with the present invention.

FIG. 3 is a swimlane diagram of a process for detecting duplicate negotiable payment instruments in accordance with the present invention.

FIG. 4 is a block diagram of a computer system in accordance with the present invention.

### DETAILED DESCRIPTION OF THE INVENTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the present invention are directed to systems and methods for reducing the risk to financial institutions that issue negotiable instruments for payments (such as a physical check, an electronic check, an Automated Clearing House (ACH) payment, a wire transfer, and the like) during the in-clearing process. In particular, embodiments of the present invention provide solutions that operate by supplying issuing financial institutions (e.g., banks that issue or print physical negotiable payment instruments) with a number of risk factors, a risk score, and/or a verification decision from the source account owner. This information may be used by the issuing financial institutions to make quicker and better-informed decisions relating to whether a particular check or other negotiable instrument is fraudulent. Embodiments may therefore improve the ability of issuing financial institutions to quickly and accurately assess risk associated with negotiable instruments, by helping them better prioritize review of the negotiable instruments they deem as high risk and be able to make a decision within 24 hours, thereby reducing the likelihood that an issuing financial institution incurs the financial risk associated with failing to identify a potentially fraudulent negotiable payment instrument within the necessary timeframe. While discussed primarily in terms of checks, it will be appreciated that the systems and methods described herein may be equally applicable to other forms of negotiable instruments.

Presently, when a payee presents a negotiable payment instrument for deposit at a depositing financial institution (e.g., a bank that accepts a physical negotiable payment instrument for deposit), the depositing financial institution may leverage a risk assessment system to provide the depositing financial institution with account information associated with the issuing bank account (e.g., source account) and/or account holder associated with the negotiable payment instrument drawn on the issuing bank account. For example, the routing number and account number printed on the negotiable payment instrument by an issuing financial institution that printed and/or issued the negotiable payment instrument may be provided to the risk assessment system, which may utilize the routing number and account number to identify information, such as risk factors, associated with the source account and/or source account owner. The risk factors may be returned to the depositing financial institution, which may use the risk factors, and possibly internal information associated with the deposit account (e.g., destination account) and/or destination account owner, to assess a level of risk associated with the negotiable payment instrument. If the depositing financial institution decides to accept the negotiable payment instrument, the depositing institution requests the funds from the issuing financial institution. At this point, the issuing financial institution has only a set time period, presently 24 hours, to determine whether the negotiable payment instrument is fraudulent. If the issuing financial institution returns a fraudulent negotiable payment instrument within 24 hours the depositing bank takes the loss. However, if the issuing financial institution returns a fraudulent negotiable payment instrument after 24 hours the issuing bank takes the loss. Conventionally, the issuing financial institution is unable to gain information and analyze risk associated about the deposit account with the depositing financial institution, thereby increasing the difficulty in quickly and accurately assessing the risk associated with a given negotiable payment instrument. This has led to issuing financial institutions bearing a disproportionate amount of burden when it comes to negotiable payment instrument in-clearing.

Embodiments of the present address these issues by having the depositing financial institution provide the risk assessment system with the routing number and account number of the destination deposit account (or other account associated with the payee if the payee is attempting to redeem the negotiable payment instrument for cash) for the negotiable payment instrument when submitting an inquiry about the source account. The routing number and account number of the destination deposit account may be used by the risk assessment system to retrieve risk factors associated with the destination depositing account at the depositing financial institution. These risk factors may be sent to the issuing financial institution for use in making a quicker and more accurate assessment of the likelihood that the negotiable payment instrument is fraudulent. In some embodiments, the risk assessment system may generate one or more risk scores that may be provided to the depositing financial institution and/or the issuing financial institution.

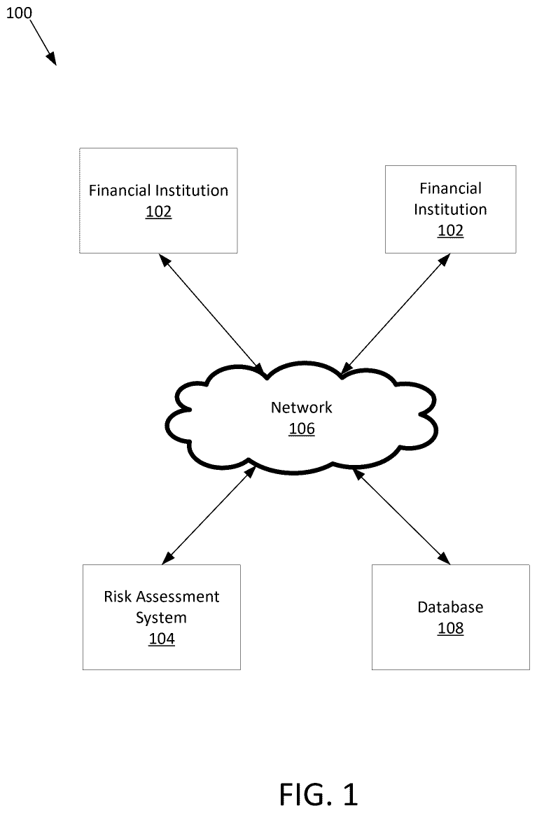

Turning now to FIG. 1, a system 100 for performing negotiable payment instrument in-clearing is illustrated. The system 100 may include a number of financial institutions 102, which may include banks, credit unions, and other entities that issue and/or accept deposits of negotiable instruments for payments, such as checks. Each financial institution 102 may maintain a number of accounts that may send and/or receive funds using negotiable payment instruments. The financial institutions 102 may make a determination of whether to accept a negotiable payment instrument or to transfer or otherwise release funds from a source account associated with a negotiable payment instrument to different destination account. This determination may involve assessing the risk of the negotiable payment instrument being fraudulent. In some embodiments, the source account and the destination account may be managed by a single financial institution 102, while in other embodiments the source account and the destination account may be managed by different financial institutions 102.

The system 100 may include a risk assessment system 104, which may be in communication with each of the financial institutions 102, such as via one or more networks 106. The risk assessment system 104 may include and/or be in communication with one or more databases 108. The databases 108 may include historical account and transaction data associated with accounts maintained at each of the financial institutions 102. For example, the databases 108 may include records (e.g., balances, transactions, account ages, average deposit amounts, etc.) of each account managed by the financial institutions 102, along with information about the owner(s) of each account, such as personally identifiable information about each owner. To facilitate the population of the databases 108, the risk assessment system 104 may establish relationships with any number of user financial institutions 102. The account and owner data associated with the accounts may be provided to the databases 108 from the financial institutions 102 themselves, in real-time and/or in batch mode. This may enable the risk assessment system 104 to access up-to-date historical and transaction data for each account and determine risk factors for accounts and/or owners thereof across a large number of financial institutions 102. The risk assessment system 104 may retrieve and/or analyze data associated with a given account and provide one or more risk factors to one or more financial institutions 102 associated with a given negotiable instrument, as will be discussed in greater detail below. The financial institutions 102 may use these risk factors to assess the risk associated with a given negotiable payment instrument and/or account owner.

Alternatively or in addition to providing risk factors to financial institutions 102, the risk assessment system 104 may perform fraud risk scoring and/or other fraud detection and mitigation services in some embodiments. The risk scores may be provided to one or more financial institutions that are associated with a given negotiable payment instrument (e.g., an issuing financial institution and/or a depositing financial institution), which may use the risk scores to further assess the risk of fraud associated with a given negotiable payment instrument. In some embodiments, the risk scores may be generated by a human-developed risk model. For example, the risk model may analyze a number of risk factors to generate a risk score associated with negotiable payment instruments to or from a given account and/or account owner. In some embodiments, the risk model may assign equal weights to each risk identifier, while in other embodiments the risk model may assign one or more of the risk factors with different weights. In some embodiments, the risk factors and/or associated weights may be selected by the risk assessment system 104, while in some embodiments each financial institution 102 may select the risk identifiers and/or associated weights that they deem important in assessing risk to be utilized in generating the risk score.

In some embodiments, the risk scores may be generated using a machine learning model. For example, the risk assessment system 104 may include a machine learning risk model (such as a Gradient Boosted Trees model) that has been trained to predict the probability that a given negotiable payment instrument is fraudulent. For example, the risk model may be provided with data from a number of prior fraudulent negotiable payment instruments and/or a number of prior valid negotiable payment instruments. The risk model may be trained to identify various fraud risk factors (including account/transaction characteristics, account history, etc.) that may be indicative of fraudulent negotiable payment instruments. The various factors may include, without limitation, an average balance of an account associated with the respective account number, a negotiable payment instrument velocity of the account associated with the respective account number, a negotiable payment instrument velocity of an account holder of the account associated with the respective account number across one or more financial institutions, an age of the account associated with the respective account number, a number of owners and signors of the account associated with the respective account number, a past risk history of the owners and signors of the account associated with the respective account number, information related to past returns on the account of the account associated with the respective account number, information related to Fair Credit Reporting Act violations of the account associated with the respective account number, information related to payment transaction fraud of the account associated with the respective account number, and/or other factors.

For example, a number of negotiable payment instruments that are known to be fraudulent and/or negotiable payment instruments that are known to be authentic may be provided to the machine learning model as input variables. Each negotiable payment instrument may include an indication of whether the particular negotiable payment instrument was fraudulent, along with other transaction and/or other information about the negotiable payment instrument, an account associated with the negotiable payment instrument (e.g., a source account and/or a destination account), and/or an owner of an account associated with the negotiable payment instrument. For example, each negotiable payment instrument may include one or more pieces of information, such as a payment amount, a time and/or date on the negotiable payment instrument, a date of presentation/deposit of the negotiable payment instrument, an address of the owner of the issuing account, a location of the presentation of the negotiable payment instrument, a recipient identifier, a sender identifier, and/or other data. Additionally, some or all of the negotiable payment instruments may include additional information related to the recipient and/or sender (e.g., account owners), such as one or more of the fraud risk factors outlined above. The negotiable payment instrument information (and possibly the additional information) may be analyzed by the machine learning model in view of the indication of whether each negotiable payment instrument was authentic or fraudulent, enabling the machine learning model to generate a number of sets of negotiable payment instrument, account owner, and/or account characteristics that are indicative of a high risk of fraud. When a new negotiable payment instrument is analyzed, the relevant information may be supplied to the machine learning model, which may identify characteristics associated with the new negotiable payment instrument to determine whether the new negotiable payment instrument is likely fraudulent. The use of such a machine learning model to generate the risk scores enables vast amounts of prior negotiable payment instrument, account, and account owner data to be analyzed to identify various risk factors that are indicative of risk that a given negotiable payment instrument is fraudulent. The machine learning risk model may be able to analyze a vast quantity of data and identify complex patterns within the data to identify risk factors that are not likely or possible to be identified using human-generated models and may provide greater accuracy in identifying fraudulent negotiable payment instruments.

In some embodiments, the risk model may behave deterministically (e.g., an inquiry with the same information scored by the model with the same feature values will always produce the same score). In other embodiments the risk model can be updated/retrained multiple times (e.g., the model can change upon retraining of the model, when the model goes through model governance, and/or when a new version of the model is deployed). In some embodiments, the risk model may be updated as new information associated with redeemed negotiable payment instruments is provided by each of the financial institutions 102 that are part of system 100. In some embodiments, the risk assessment system 104 may monitor current negotiable payment instrument scams and other fraudulent activity. For example, the risk assessment system 104 may receive information on fraudulent negotiable payment instruments and scams from the various user financial institutions 102 and/or other external sources. The risk assessment system 104 and/or risk model may analyze this information to identify characteristics that are indicative of such fraud. For example, the risk assessment system 104 and/or risk model may be supplied with information from known fraudulent negotiable payment instrument transactions to identify combinations of different fraud risk factors (such as those described above) that may be indicative of a fraudulent negotiable payment instrument based on the information on fraudulent negotiable payment instruments and scams provided by the various user financial institutions 102 and/or other external sources. The risk assessment system 104 may also maintain and update information and educational resources on the various fraudulent activities that may be used to instruct the financial institutions 102 on how to handle various fraudulent activity. For example, information on what the financial institutions 102 should look for to detect fraudulent negotiable payment instruments and/or steps that may be taken to avoid and/or reduce the threat of falling victim to fraud. The risk assessment system 104 may monitor trends in various scams, which may be used to keep information up to date and to best educate the various partner financial institutions 102 of the risk assessment system 104.

As noted above, the financial institutions 102 and the risk assessment system 104, and/or databases 108 may be connected via one or more wired and/or wireless networks 106. Data transmitted across the networks 106 may be secured using encryption techniques, hypertext transfer protocol secure (HTTPS), secure sockets layer (SSL), transport layer security (TLS), and/or other security protocol.

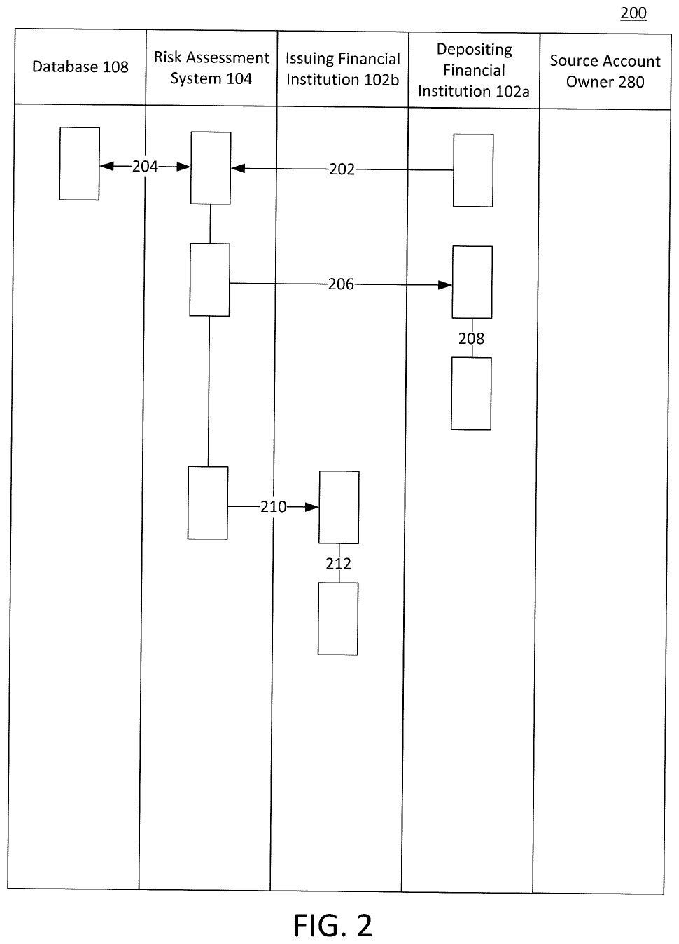

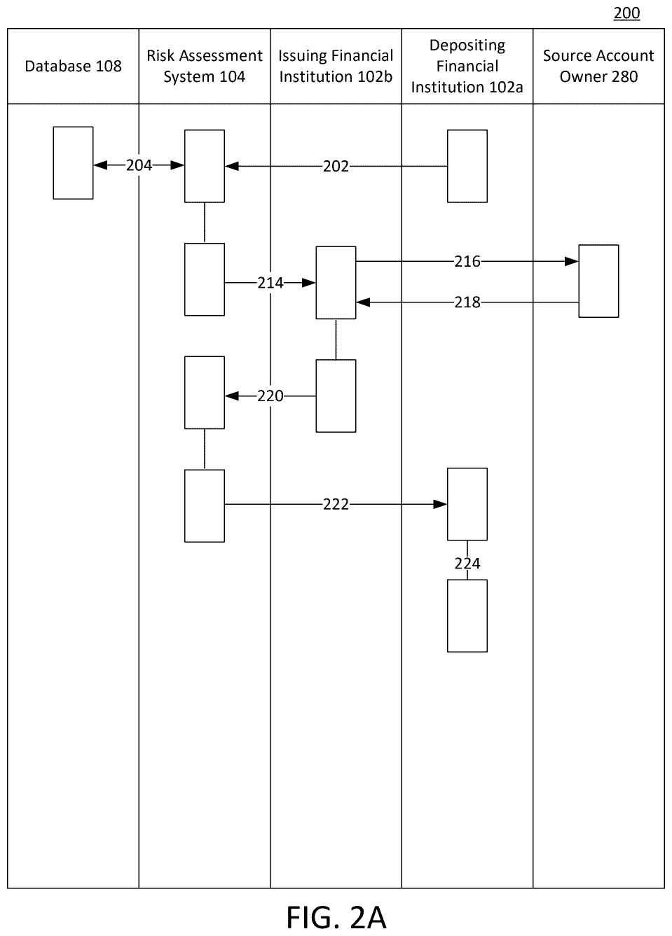

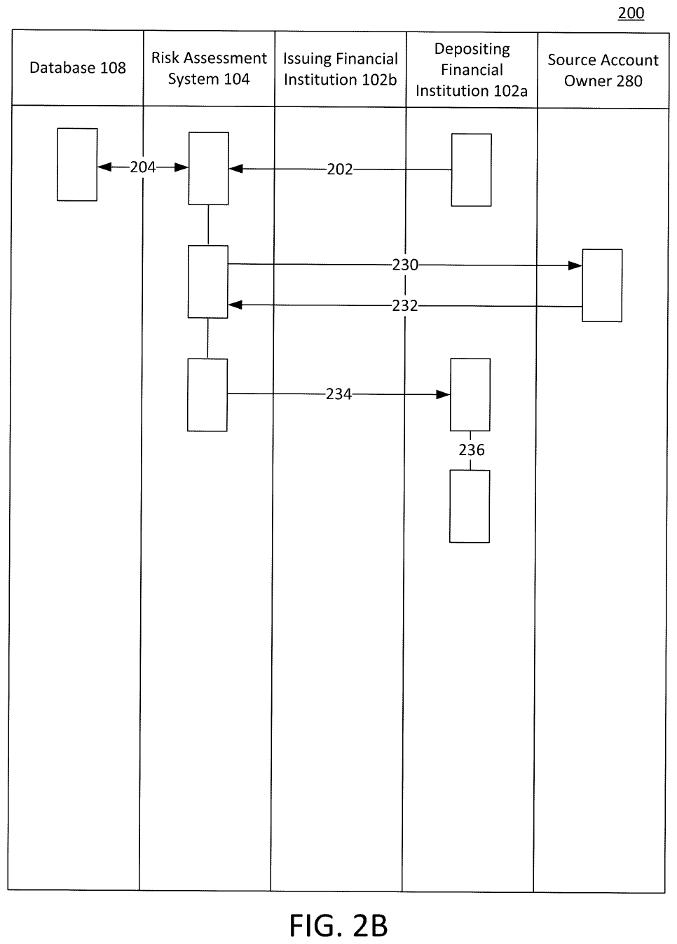

FIG. 2 illustrates a swimlane diagram showing interactions between different entities of system 100 as part of a negotiable payment instrument in-clearing procedure or process 200. The negotiable payment instrument in-clearing process 200 may be initiated by a payee presenting a negotiable payment instrument to a depositing financial institution 102a for deposit in a destination account managed by the depositing financial institution 102a. At operation 202, the depositing financial institution 102a (e.g., a financial institution 102 associated with the destination account) may submit a deposit inquiry to the risk assessment system 104. The deposit inquiry may be associated with the negotiable payment instrument that has been presented to the depositing financial institution 102a. The deposit inquiry may include a routing number associated with an issuing financial institution 102b (e.g., a financial institution 102 that issued the negotiable payment instrument and that maintains a source account associated with the negotiable payment instrument) and an account number at the issuing financial institution 102b of the source account linked to the negotiable payment instrument. In some embodiments, the data inquiry may provide the routing number associated with the issuing financial institution 102b and account number of the source account as alphanumeric data fields. Alternatively or additionally, the data inquiry may include an image of the front of the negotiable payment instrument which contains the printed routing number of the issuing financial institution and account number of the source account. The deposit inquiry may also include a routing number of the depositing financial institution 102a and account number of the destination account. Thus, the deposit inquiry may include routing numbers and account numbers that identify both the source account from the issuing financial institution 102b and the destination account from the depositing financial institution 102a.

At operation 204, the risk assessment system 104 may use the routing numbers and account numbers associated with the source account and/or the destination account to identify one or more risk factors associated with the source account and/or the owner of the source account, as well as one or more risk factors associated with the destination account and/or the owner of the destination account. For example, the risk assessment system 104 may access the databases 108 and use the routing numbers and account numbers to look up and retrieve stored historical and transaction data associated with each account. The risk assessment system 104 may also retrieve information associated with the owner of one or both accounts, including account history and transaction data associated with other accounts held by each account owner at one or more financial institutions. For example, as part of the ongoing relationship with the risk assessment system 104, each financial institution 102 within the system 100 may provide the historical and transaction data associated with the various accounts the financial institution 102 manages. This information may include one or more identifiers associated with each owner (or owners, if the account is a joint account) of each account such as, but not limited to, the owner's name, an email address, a social security number, a phone number, a mailing address, and/or other personally identifiable information. The risk assessment system 104 may use this personally identifiable information from each account owner to lookup and retrieve additional information associated with the owner(s) from the databases 108. For example, the risk assessment system 104 may access account data, transaction data, and/or other data from one or more other accounts (from the same and/or different financial institution 102) associated with the account owner.

The risk assessment system 104 may retrieve or determine a number of risk identifiers associated with the source account and/or the destination account. In some embodiments, the risk assessment system 104 may retrieve or determine a number of risk identifiers associated with owners of one or both of the source account and the destination account. The risk factors may be or include raw data retrieved from the databases 108 and/or may be generated through analysis of the raw data retrieved from the databases 108. The risk factors may include, without limitation, an average balance of an account associated with the respective account number, a negotiable payment instrument velocity of the account associated with the respective account number, a negotiable payment instrument velocity of an account holder of the account associated with the respective account number across one or more financial institutions, an age of the account associated with the respective account number, a number of owners and signors of the account associated with the respective account number, a past risk history of the owners and signors of the account associated with the respective account number, information related to past returns on the account of the account associated with the respective account number, information related to Fair Credit Reporting Act violations of the account associated with the respective account number, information related to payment transaction fraud of the account associated with the respective account number, and/or other factors.

At operation 206, the risk assessment system 104 may send the risk factors associated with the source account and/or owner of the source account to the depositing financial institution 102a. The depositing financial institution 102a may utilize the risk factors to determine whether the negotiable payment instrument is accurate or fraudulent and whether to accept the negotiable payment instrument at operation 208. The risk assessment system 104 may send the risk factors associated with the destination account and/or owner of the destination account to the issuing financial institution 102b at operation 210. The issuing financial institution 102b may utilize the risk factors to determine whether the negotiable payment instrument is accurate or fraudulent and whether to initiate the transfer of funds from the source account to the destination account or report the negotiable payment instrument as fraudulent at operation 212.

In embodiments in which the image of the negotiable payment instrument is provided to the risk assessment system 104, the risk assessment system 104 may use the image to perform various functions. For example, the risk assessment system 104 may perform Account Owner Authentication (AOA) operations on the image of the negotiable payment instrument to determine the routing number and account number of the source account and/or to determine the source account owner 280. In some embodiments, AOA operations may be performed as described in U.S. Pat. No. 7,337,953 entitled “Negotiable Instrument Authentication Systems and Methods” filed on Mar. 18, 2005, U.S. Pat. No. 8,682,764 entitled “System and Method for Suspect Entity Detection and Migration”filed on Mar. 1, 2012, and U.S. Pat. No. 10,748,154 entitled “System and Method Using Multiple Profiles and Scores for Assessing Financial Transaction Risk” filed Dec. 23, 2016, the entire contents of which are hereby incorporated by reference. As shown in FIG. 2A, in some embodiments, the risk assessment system 104 may send the image of the negotiable payment instrument, as well as information associated with the source account owner 280, to the issuing financial institution 102b at operation 214. The issuing financial institution 102b may use the information associated with the source account owner 280 to look up one or more contact identifiers of the source account owner 280 such as electronic messaging addresses of the source account owner 280 and send an electronic message to the source account owner 280 at operation 216, such as using short messaging service (SMS), a push notification within a mobile application of the issuing financial institution 102b, email, and/or other messaging protocol. The electronic message may include the image of the negotiable payment instrument. The source account owner 280 may view the information provided and/or image of the negotiable payment instrument and respond to the electronic message with a verification decision at operation 218. For example, the source account owner 280 may send the verification decision to the issuing financial institution 102b electronically using a same or different message protocol as used to send the electronic message. The verification decision may include a confirmation from the source account owner 280 that the negotiable payment instrument is accurate (e.g., the payee name on the imaged negotiable payment instrument, the account number, the amount, etc. are all confirmed as being accurate and authorized by the source account owner 280) or that the negotiable payment instrument is fraudulent (e.g., the payee name has been altered, the negotiable payment instrument has been altered from a different account to be drawn on the source account owner's account, the negotiable payment instrument has been forged, etc.). Once received by the issuing financial institution 102b, the verification decision may be sent to the risk assessment system 104 at operation 220, which may forward the verification decision to the depositing financial institution 102a at operation 222. At operation 224, the depositing financial institution 102a may release funds to the destination account or mark the negotiable payment instrument as being fraudulent based on the verification decision.

As shown in FIG. 2B, in some embodiments, the risk assessment system 104 may send the image of the negotiable payment instrument, as well as information associated with the source account owner 280, directly to the source account owner 280 at operation 230. For example, the risk assessment system 104 may use the routing number and account number on the negotiable payment instrument to identify the source account owner 280 and at least one contact identifier of the source account owner 280 such as an electronic messaging address of the source account owner 280 using the databases 108 and/or other banking information (such as peer to peer payment application data). The image of the negotiable payment instrument may be sent to the source account owner 280 using SMS, email, and/or other messaging protocol. The source account owner 280 may view the image of the negotiable payment instrument and respond to the risk assessment system 104 with a verification decision at operation 232. For example, the source account owner 280 may send the verification decision to the risk assessment system 104 electronically using a same or different message protocol as used to send the image of the negotiable payment instrument. The risk assessment system 104 may send the verification decision to the depositing financial institution 102a at operation 234. At operation 236, the depositing financial institution 102a may release funds to the destination account or mark the negotiable payment instrument as being fraudulent based on the verification decision.

In some embodiments, along with, or instead of, sending the risk factors and/or verification decision to the depositing financial institution 102a and/or the issuing financial institution 102b, the risk assessment system 104 may generate and send a risk score to one or both of the financial institutions associated with the negotiable payment instrument. For example, the routing number and account number of the source account and/or the destination account, possibly with an image of the negotiable payment instrument, may be provided to a risk model of the risk assessment system 104. In some embodiments, the risk model may be a human-generated risk model in which a number of inputs (e.g., risk factors) associated with the negotiable payment instrument, the source account, the destination account, the account owners, and/or other data may be analyzed and/or weighted to produce a risk score. In other embodiments, the risk model may include a machine learning risk model that has been trained to generate risk scores based on the inputs. For example, historical and/or transactional information associated with one or both accounts and/or owners of one or both accounts may be retrieved from the databases 108 and provided to the machine learning risk model. The machine learning risk model may analyze the data and generate a risk score that is indicative of a probability that the negotiable payment instrument is fraudulent. The risk scores may be supplied to the relevant financial institutions 102 along with, or in place of, the risk factors at operations 206 and/or 210. For example, the risk score associated with the source account and/or source account owner 280 may be sent to the depositing financial institution 102a for use in determining whether to accept the negotiable payment instrument, while the risk score associated with the destination account and/or destination account owner may be sent to the issuing financial institution 102b for use in determining whether to release the funds associated with the negotiable payment instrument. In some embodiments, the depositing financial institution 102a and/or issuing financial institution 102b may be provided with both risk scores to further enhance the ability of the respective financial institution 102 to determine a level of risk associated with the negotiable payment instrument.

The deposit inquiries may be provided to the risk assessment system 104 in batches (e.g., periodically) or may be provided in real-time. In some embodiments in which the deposit inquiries are sent in real-time, the risk assessment system 104 may also prevent a single negotiable payment instrument from being redeemed (e.g., cashed or deposited) multiple times. Duplicate negotiable payment instrument redemption is a problem that has become particularly prevalent since the introduction of online negotiable payment instrument deposits, as users may attempt to electronically deposit a single negotiable payment instrument into multiple accounts across different financial institutions 102 in rapid succession. Given the relationships that the risk assessment system 104 has established with numerous financial institutions 102, the risk assessment system 104 may be able to access real-time or near real-time information about negotiable payment instrument redemptions across any number of accounts and financial institutions 102. For example, each financial institution 102 may submit to the risk assessment system 104 and/or a database 108 thereof, in real-time or near real-time, a record of each negotiable payment instrument redemption (or attempted redemption) at the respective financial institution 102. This enables the risk assessment system 104 to maintain and access information related to any negotiable payment instrument redeemed within the network of financial institutions 102.

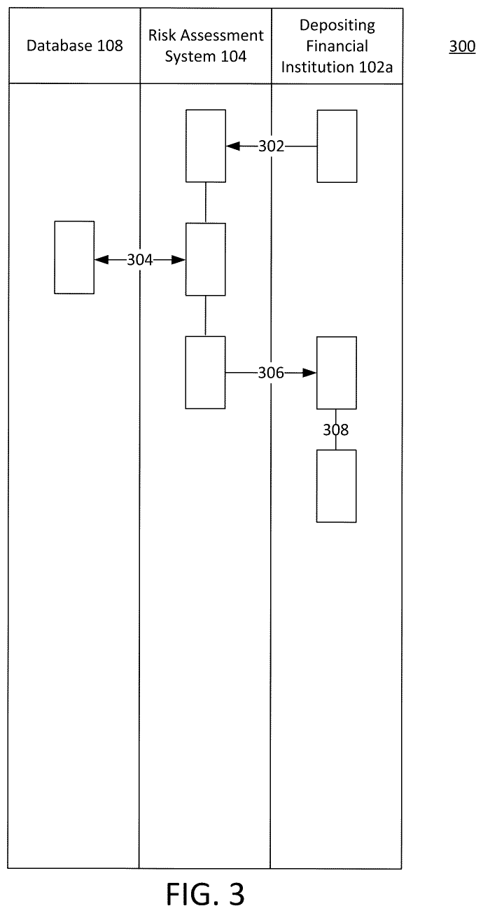

FIG. 3 is a swimlane diagram illustrating a process 300 of checking for duplicate negotiable payment instruments. It will be appreciated that process 300 may be performed as part of, simultaneously to, and/or independent of process 200 described above. Process 300 may begin at operation 302 by the depositing financial institution 102a sending a deposit inquiry to the risk assessment system 104. The deposit inquiry may be the same or different than the deposit inquiry of process 200 and may include information such as a routing number and account number printed on the negotiable payment instrument, a date of the negotiable payment instrument, a number or other identifier of the negotiable payment instrument, an image of the negotiable payment instrument, and/or other information that may be used to identify the negotiable payment instrument. At operation 304, the risk assessment system 104 may compare at least a portion of the information from the deposit inquiry to prior known negotiable payment instrument redemptions and/or attempts to determine whether the negotiable payment instrument has been redeemed previously with information stored by databases 108. For example, the risk assessment system 104 may compare a routing number, account number, and negotiable payment instrument number of the negotiable payment instrument to those of prior known negotiable payment instrument redemptions and/or attempts and provide the depositing financial institution 102a with an indication of whether the negotiable payment instrument has been previously presented at another financial institution at operation 306. For example, if a matching negotiable payment instrument is located, the risk assessment system 104 may determine that the negotiable payment instrument is a duplicate and may inform the depositing financial institution 102a of the duplicate status. If no matching negotiable payment instrument is located, the risk assessment system 104 may determine that the negotiable payment instrument is not a duplicate and inform the depositing financial institution 102a that no duplicate issues are present. Based on the information from the risk assessment system 104, the depositing financial institution 102a may determine whether to accept or deny the negotiable payment instrument at operation 308.

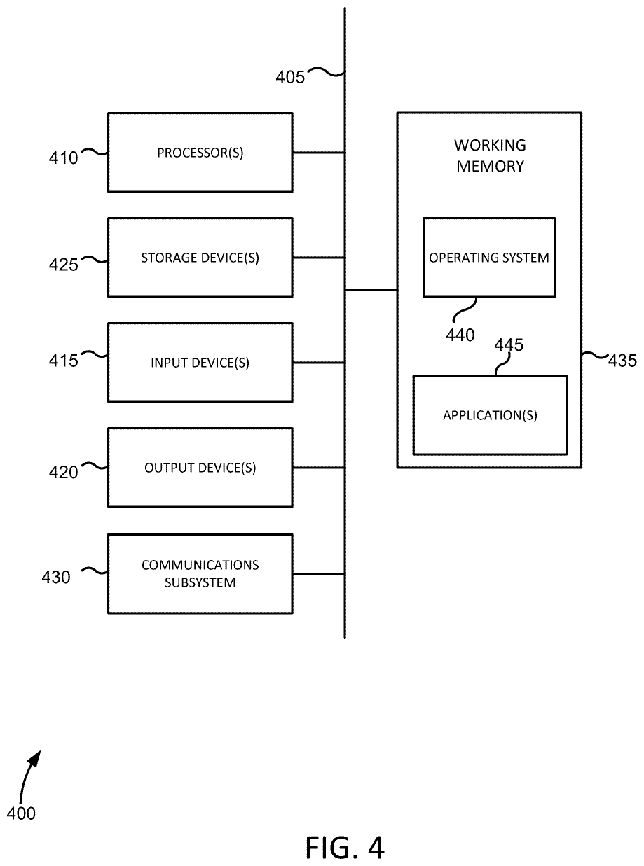

A computer system as illustrated in may be incorporated as part of the previously described computerized devices. For example, computer system 400 can represent some of the components of computing devices, such as the financial institutions 102, risk assessment system 104, databases 108, source account owner 280, and/or other computing devices described herein. FIG. 4 provides a schematic illustration of one embodiment of a computer system 400 that can perform the methods provided by various other embodiments, as described herein. FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 405 (or may otherwise be in communication, as appropriate). The hardware elements may include a processing unit 410, including without limitation one or more processors, such as one or more central processing units (CPUs), graphical processing units (GPUs), special-purpose processors (such as digital signal processing chips, graphics acceleration processors, and/or the like); one or more input devices 415, which can include without limitation a keyboard, a touchscreen, receiver, a motion sensor, a camera, a smartcard reader, a contactless media reader, and/or the like; and one or more output devices 420, which can include without limitation a display device, a speaker, a printer, a writing module, and/or the like.

The computer system 400 may further include (and/or be in communication with) one or more non-transitory storage devices 425, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 400 might also include a communication interface 430, which can include without limitation a modem, a network card (wireless or wired), an infrared communication device, a wireless communication device and/or chipset (such as a Bluetooth™ device, an 502.11 device, a Wi-Fi device, a WiMAX device, an NFC device, cellular communication facilities, etc.), and/or similar communication interfaces. The communication interface 430 may permit data to be exchanged with a network (such as the network described below, to name one example), other computer systems, and/or any other devices described herein. In many embodiments, the computer system 400 will further comprise a non-transitory working memory 435, which can include a RAM or ROM device, as described above.

The computer system 400 also can comprise software elements, shown as being currently located within the working memory 435, including an operating system 440, device drivers, executable libraries, and/or other code, such as one or more application programs 445, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such special/specific purpose code and/or instructions can be used to configure and/or adapt a computing device to a special purpose computer that is configured to perform one or more operations in accordance with the described methods.

A set of these instructions and/or code might be stored on a computer-readable storage medium, such as the storage device(s) 425 described above. In some cases, the storage medium might be incorporated within a computer system, such as computer system 400. In other embodiments, the storage medium might be separate from a computer system (e.g., a removable medium, such as a compact disc), and/or provided in an installation package, such that the storage medium can be used to program, configure and/or adapt a special purpose computer with the instructions/code stored thereon. These instructions might take the form of executable code, which is executable by the computer system 400 and/or might take the form of source and/or installable code, which, upon compilation and/or installation on the computer system 400 (e.g., using any of a variety of available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system. For example, a risk management engine configured to provide some or all of the features described herein relating to the risk profiling and/or distribution can comprise hardware and/or software that is specialized (e.g., an application-specific integrated circuit (ASIC), a software method, etc.) or generic (e.g., processing unit 410, applications 445, etc.) Further, connection to other computing devices such as network input/output devices may be employed.

Some embodiments may employ a computer system (such as the computer system 400) to perform methods in accordance with the disclosure. For example, some or all of the procedures of the described methods may be performed by the computer system 400 in response to processing unit 410 executing one or more sequences of one or more instructions (which might be incorporated into the operating system 440 and/or other code, such as an application program 445) contained in the working memory 435. Such instructions may be read into the working memory 435 from another computer-readable medium, such as one or more of the storage device(s) 425. Merely by way of example, execution of the sequences of instructions contained in the working memory 435 might cause the processing unit 410 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 400, various computer-readable media might be involved in providing instructions/code to processing unit 410 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 425. Volatile media include, without limitation, dynamic memory, such as the working memory 435. Transmission media include, without limitation, coaxial cables, copper wire, and fiber optics, including the wires that comprise the bus 405, as well as the various components of the communication interface 430 (and/or the media by which the communication interface 430 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a magnetic medium, optical medium, or any other physical medium with patterns of holes, a RAM, a PROM, EPROM, a FLASH-EPROM, any other memory chip or cartridge, a carrier wave as described hereinafter, or any other medium from which a computer can read instructions and/or code.

The communication interface 430 (and/or components thereof) generally will receive the signals, and the bus 405 then might carry the signals (and/or the data, instructions, etc. carried by the signals) to the working memory 435, from which the processor(s) 410 retrieves and executes the instructions. The instructions received by the working memory 435 may optionally be stored on a non-transitory storage device 425 either before or after execution by the processing unit 410.

In the embodiments described above, for the purposes of illustration, processes may have been described in a particular order. It should be appreciated that in alternate embodiments, the methods may be performed in a different order than that described. It should also be appreciated that the methods and/or system components described above may be performed by hardware and/or software components (including integrated circuits, processing units, and the like), or may be embodied in sequences of machine-readable, or computer-readable, instructions, which may be used to cause a machine, such as a general-purpose or special-purpose processor or logic circuits programmed with the instructions to perform the methods. These machine-readable instructions may be stored on one or more machine-readable mediums, such as CD-ROMs or other type of optical disks, floppy disks, ROMs, RAMs, EPROMs, EEPROMs, magnetic or optical cards, flash memory, or other types of machine-readable mediums suitable for storing electronic instructions. Alternatively, the methods may be performed by a combination of hardware and software.

The methods, systems, devices, graphs, and tables discussed herein are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims. Additionally, the techniques discussed herein may provide differing results with different types of context awareness classifiers.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As defined herein, real-time, can in some embodiments, be defined with respect to operations carried out as soon as practically possible upon the occurrence of a triggering event. A triggering event can include receipt of data necessary to execute a task or to otherwise process information. Due to delays that are inherent in data transmission and/or in computing speeds, the term real-time encompasses operations that occur in “near” real-time or somewhat delayed from a triggering event. In a number of embodiments, real-time can mean real-time less a time delay for processing (e.g., determining) and/or transmitting data. The particular time delay can vary depending on the type and/or amount of the data, the processing speeds of the hardware, the transmission capability of the communication hardware, the transmission distance, and the like. However, in many embodiments, the time delay can be less than approximately one second, five seconds, ten seconds, thirty seconds, one minute, or five minutes.

As defined herein, batch mode, can in some embodiments, be defined with respect to operations carried out at a scheduled time interval upon the occurrence of a triggering event. A triggering event can include receipt of data necessary to execute a task or to otherwise process information. The particular scheduled time interval can vary depending on the type and/or amount of the data. However, in many embodiments, the scheduled time interval for the batch mode can be less than approximately 30 minutes, 1 hour, 3 hours, 6, hours, 12, hours, or 24 hours.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

1. A risk assessment system, comprising:
one or more processors; and
a memory having instructions stored thereon that, when executed by the one or more processors, cause the one or more processors to:
receive, via one or more communication networks, a deposit inquiry from a depositing financial institution, the deposit inquiry comprising:
a first routing number associated with an issuing financial institution;
a first account number associated with a check issued by the issuing financial institution, wherein the issuing financial institution has a set time period from when the depositing financial institution requests funds for the check to determine whether the check is fraudulent;
a second routing number associated with a deposit account into which funds from the check are to be deposited; and
a second account number associated with the deposit account;
retrieve, via the one or more communication networks, historical data and transaction data associated with an issuing account having the first account number using the first account number and the first routing number, the historical data and the transaction data associated with the issuing account comprising owner identification information associated with the issuing account;
retrieve, via the one or more communication networks, historical data and transaction data associated with the deposit account using the second account number and the second routing number, the historical data and the transaction data associated with the deposit account comprising owner identification information associated with the deposit account;
identify an owner of the issuing account based on the owner identification information associated with the issuing account;
identify an owner of the deposit account based on the owner identification information associated with the deposit account;
retrieve, via the one or more communication networks, historical data and transaction data associated with one or more accounts of the owner of the issuing account;
retrieve, via the one or more communication networks, historical data and transaction data associated with one or more accounts of the owner of the deposit account;
analyze the historical data and transaction data associated with the issuing account and the historical data and transaction data associated with the one or more accounts of the owner of the issuing account to identify one or more risk factors associated with the issuing account and the owner of the issuing account;
analyze the historical data and transaction data associated with the deposit account and the historical data and transaction data associated with the one or more accounts of the owner of the deposit account to identify one or more risk factors associated with the deposit account and the owner of the deposit account;
provide, via the one or more communication networks, the one or more risk factors associated with the issuing account and the owner of the issuing account to the depositing financial institution; and
provide, via the one or more communication networks, the one or more risk factors associated with the deposit account and the owner of the deposit account to the issuing financial institution prior to expiration of the set time period.

2. The risk assessment system of claim 1, wherein:
the one or more risk factors associated with the issuing account and the owner of the issuing account and the one or more risk factors associated with the deposit account and the owner of the deposit account comprise at least one of:
an average balance of an account associated with the respective account number;
a check velocity of the account associated with the respective account number;
a check velocity of an account holder of the account associated with the respective account number across one or more financial institutions;
an age of the account associated with the respective account number;
a number of owners and signors of the account associated with the respective account number;
a past risk history of the owners and signors of the account associated with the respective account number;
information related to past returns on the account associated with the respective account number;
information related to Fair Credit Reporting Act violations of the account associated with the respective account number; or
information related to payment transaction fraud of the account associated with the respective account number.

3. The risk assessment system of claim 1, wherein:
the deposit inquiry comprises an image of the check, the image comprising the first routing number and the first account number;
the instructions further cause the one or more processors to:
extract the first routing number and the first account number from the image of the check;
send the image of the check, the first routing number, and the first account number to the issuing financial institution;
receive a verification decision from the issuing financial institution, the verification decision indicating whether the owner of the issuing account has marked the check as accurate or fraudulent; and
provide the verification decision to the depositing financial institution.

4. The risk assessment system of claim 1, wherein:
the deposit inquiry comprises an image of the check, the image comprising the first routing number and the first account number;
the instructions further cause the one or more processors to:
extract the first routing number and the first account number from the image of the check;
determine an electronic messaging address of the owner of the issuing account;
send the image of the check, the first routing number, and the first account number to the electronic messaging address of the owner of the issuing account;
receive a verification decision from the owner of the issuing account, the verification decision indicating whether the owner of the issuing account has marked the check as accurate or fraudulent; and
provide the verification decision to the depositing financial institution.

5. The risk assessment system of claim 4, wherein:
the electronic messaging address comprises at least one of a phone number, an email address, or an identifier associated with a mobile application associated with the issuing financial institution.

6. (canceled)

7. The risk assessment system of claim 1, wherein:
the deposit inquiry is one of a plurality of deposit inquiries that are received by the risk assessment system in a batch.

8. The risk assessment system of claim 1, wherein the instructions further cause the one or more processors to:
determine whether the check has been previously presented at another financial institution; and
provide an indication of whether the check has been previously presented at another financial institution to the depositing financial institution.

9. A method of assessing risk of a check, comprising:
receiving, by a risk assessment system via one or more communication networks, a deposit inquiry from a depositing financial institution, the deposit inquiry comprising:
a first routing number associated with an issuing financial institution;
a first account number associated with a check issued by the issuing financial institution, wherein the issuing financial institution has a set time period from when the depositing financial institution requests funds for the check to determine whether the check is fraudulent;
a second routing number associated with a deposit account into which funds from the check are to be deposited; and
a second account number associated with the deposit account;
retrieving, via the one or more communication networks, historical data and transaction data associated with an issuing account having the first account number using the first account number and the first routing number, the historical data and the transaction data associated with the issuing account comprising owner identification information associated with the issuing account;
retrieving, via the one or more communication networks, historical data and transaction data associated with the deposit account using the second account number and the second routing number, the historical data and the transaction data associated with the deposit account comprising owner identification information associated with the deposit account;
identifying an owner of the issuing account based on the owner identification information associated with the issuing account;
identifying an owner of the deposit account based on the owner identification information associated with the deposit account;
retrieving, via the one or more communication networks, historical data and transaction data associated with one or more accounts of the owner of the issuing account;
retrieving, via the one or more communication networks, historical data and transaction data associated with one or more accounts of the owner of the deposit account;
analyzing the historical data and transaction data associated with the issuing account and the historical data and transaction data associated with the one or more accounts of the owner of the issuing account to identify one or more risk factors associated with the issuing account and the owner of the issuing account;
analyzing the historical data and transaction data associated with the deposit account and the historical data and transaction data associated with the one or more accounts of the owner of the deposit account to identify one or more risk factors associated with the deposit account and the owner of the deposit account;
providing, by the risk assessment system via the one or more communication networks, the one or more risk factors associated with the issuing account and the owner of the issuing account to the depositing financial institution; and
providing, by the risk assessment system via the one or more communication networks, the one or more risk factors associated with the deposit account and the owner of the deposit account to the issuing financial institution prior to expiration of the set time period.

10. The method of assessing risk of a check of claim 9, further comprising:
generating a risk score based at least in part on the one or more risk factors associated with the issuing account and the owner of the issuing account; and
sending the risk score to the depositing financial institution.

11. The method of assessing risk of a check of claim 9, further comprising:
generating a risk score based at least in part on the one or more risk factors associated with the deposit account and the owner of the deposit account; and
sending the risk score to the issuing financial institution.

12. The method of assessing risk of a check of claim 9, further comprising:
using a machine learning model to generate at least one risk score, wherein the at least one risk score comprises one or both of a first risk score associated with the first account number and a second risk score associated with the second account number; and
sending the at least one risk score to one or both of the issuing financial institution and the depositing financial institution.

13. The method of assessing risk of a check of claim 12, wherein:
the machine learning model is trained using historical information from known fraudulent checks.

14. The method of assessing risk of a check of claim 12, wherein:
the deposit inquiry is received in real-time immediately upon the depositing financial institution accepting the check.

15. A non-transitory machine-readable medium having instructions stored thereon that, when executed by one or more processors, cause the one or more processors to:
receive, via one or more communication networks, a deposit inquiry from a depositing financial institution, the deposit inquiry comprising:
a first routing number associated with an issuing financial institution;
a first account number associated with a check issued by the issuing financial institution, wherein the issuing financial institution has a set time period from when the depositing financial institution requests funds for the check to determine whether the check is fraudulent;
a second routing number associated with a deposit account into which funds from the check are to be deposited; and
a second account number associated with the deposit account;
retrieve, via the one or more communication networks, historical data and transaction data associated with an issuing account having the first account number using the first account number and the first routing number, the historical data and the transaction data associated with the issuing account comprising owner identification information associated with the issuing account;
retrieve, via the one or more communication networks, historical data and transaction data associated with the deposit account using the second account number and the second routing number, the historical data and the transaction data associated with the deposit account comprising owner identification information associated with the deposit account;
identify an owner of the issuing account based on the owner identification information associated with the issuing account;
identify an owner of the deposit account based on the owner identification information associated with the deposit account;
retrieve, via the one or more communication networks, historical data and transaction data associated with one or more accounts of the owner of the issuing account;
retrieve, via the one or more communication networks, historical data and transaction data associated with one or more accounts of the owner of the deposit account;
analyze the historical data and transaction data associated with the issuing account and the historical data and transaction data associated with the one or more accounts of the owner of the issuing account to identify one or more risk factors associated with the issuing account and the owner of the issuing account;
analyze the historical data and transaction data associated with the deposit account and the historical data and transaction data associated with the one or more accounts of the owner of the deposit account to identify one or more risk factors associated with the deposit account and the owner of the deposit account;
provide, via the one or more communication networks, the one or more risk factors associated with the issuing account and the owner of the issuing account to the depositing financial institution; and
provide, via the one or more communication networks, the one or more risk factors associated with the deposit account and the owner of the deposit account to the issuing financial institution prior to expiration of the set time period.

16. The non-transitory machine-readable medium of claim 15, wherein:
the deposit inquiry comprises an image of the check, the image comprising the first routing number and the first account number;
the instructions further cause the one or more processors to:
extract the first routing number and the first account number from the image of the check;
send the image of the check, the first routing number, and the first account number to the issuing financial institution;
receive a verification decision from the issuing financial institution, the verification decision indicating whether the owner of the issuing account has marked the check as accurate or fraudulent; and
provide the verification decision to the depositing financial institution.

17. The non-transitory machine-readable medium of claim 15, wherein:
the deposit inquiry comprises an image of the check, the image comprising the first routing number and the first account number;
the instructions further cause the one or more processors to:
extract the first routing number and the first account number from the image of the check;
determine an electronic messaging address of the owner of the issuing account;
send the image of the check, the first routing number, and the first account number to the electronic messaging address of the owner of the issuing account;
receive a verification decision from the owner of the issuing account, the verification decision indicating whether the owner of the issuing account has marked the check as accurate or fraudulent; and
provide the verification decision to the depositing financial institution.

18. The non-transitory machine-readable medium of claim 15, wherein the instructions further cause the one or more processors to:
generate a risk score based at least in part on the one or more risk factors associated with the issuing account and the owner of the issuing account; and
send the risk score to the depositing financial institution.

19. The non-transitory machine-readable medium of claim 15, wherein the instructions further cause the one or more processors to:
generate a risk score based at least in part on the one or more risk factors associated with the deposit account and the owner of the deposit account; and
send the risk score to the issuing financial institution.

20. The non-transitory machine-readable medium of claim 15, wherein the instructions further cause the one or more processors to:
use a machine learning model to generate at least one risk score, wherein the at least one risk score comprises one or both of a first risk score associated with the first account number and a second risk score associated with the second account number; and
send the at least one risk score to one or both of the issuing financial institution and the depositing financial institution.
